(19) United States
(12) Patent Application Publication
(10) Pub. No.: US 2025/0141549 A1
(43) Pub. Date: May 1, 2025

(54) OPTICAL SYSTEMS HAVING A WAVELENGTH CONVERSION MATERIAL FOR OPTICAL SIGNAL DETECTION

(71) Applicant: CORNING RESEARCH & DEVELOPMENT CORPORATION, Corning, NY (US)

(72) Inventors: David Francis Dawson-Elli, Charlotte, NC (US); Lingling Hu, Fort Worth, TX (US); Peter Gerard Wigley, Corning, NY (US)

(21) Appl. No.: 18/385,161

(22) Filed: Oct. 30, 2023

(51) Int. Cl. H04B 10/25; H04B 10/572

(52) U.S. Cl. CPC H04B 10/25; H04B 10/572

(57) ABSTRACT

In one embodiment, an optical system includes an optical cable assembly includes an optical cable includes at least one optical fiber and an optical connector positioned on an end of the optical cable, where the at least one optical fiber is operable to propagate an optical signal having a communication wavelength, and a wavelength conversion material positioned within an optical path of the optical signal emitted by an end of the at least one optical fiber, where the wavelength conversion material converts the communication wavelength of the optical signal to a detection wavelength.

### FIELD

The present disclosure is directed to optical communication systems and, more particularly, optical systems having a wavelength conversion material for enabling optical signal detection.

### BACKGROUND

Optical fiber is increasingly being used for a variety of applications, including but not limited to broadband voice, video, and data transmission. As bandwidth demands increase optical fiber is migrating deeper into communication networks such as in fiber to the premises applications such as FTTx, 5G and the like. As optical fiber extended deeper into communication networks the need for making robust optical connections in outdoor applications in a quick and easy manner was apparent.

Fiber to the premises (FTTP) is the installation of optical fiber direct to individual buildings such as single-family units, multi-dwelling units, and businesses to provide high-speed broadband access. FTTP dramatically increases connection speeds and reliability for broadband networks compared to legacy copper infrastructure.

In some instances, a network issue may prevent optical communication from occurring at a subscriber location. The network issue may be upstream from the subscriber location (e.g., an optical fiber, a distribution hub, a central office) or within the subscriber location (e.g., a router or a modem). Knowing the location of the issue can significantly reduce troubleshooting time and costs.

Accordingly, a need exists for alternative optical systems and methods for determining whether or not an optical signal is present at a subscriber location.

### SUMMARY

The present disclosure is directed to optical systems and methods that incorporate a wavelength conversion material to detect the presence or lack of presence of an optical signal when performing a network diagnostic test. The wavelength conversion material allows users, such as homeowners, renters, and business owners, to perform diagnostic tests on their own without the need for technicians. Embodiments may utilize a smart device, such as a mobile phone, to perform optical signal verification and reporting to the service provider.

In one embodiment, an optical system includes an optical cable assembly which includes at least one optical fiber and an optical connector positioned on an end of the optical cable, where the at least one optical fiber is operable to propagate an optical signal having a communication wavelength, and a wavelength conversion material positioned within an optical path of the optical signal emitted by an end of the at least one optical fiber, where the wavelength conversion material converts the communication wavelength of the optical signal to a detection wavelength.

In another embodiment, a method of determining a status of an optical communication link, the method includes receiving image data of a wavelength conversion material positioned to receive an optical signal having a communication wavelength, where the wavelength conversion material is operable to convert the communication wavelength of the optical signal to a detection wavelength, and processing the image data to determine a presence or lack of presence of an illumination region that is illuminated by the optical signal. The method also includes providing a success indication when the processing of the image data is indicative of a presence of an illumination region.

In another embodiment, a method of determining a status of an optical communication link, the method includes placing a substrate which includes a wavelength conversion material over a camera of an electronic device, positioning a light shield over an optical connector of an optical cable assembly, where the light shield includes a first opening, second opening, and a passage between the first opening and the second opening, and placing the second opening of the light shield over the wavelength conversion material and the camera of the electronic device.

Additional features and advantages will be set forth in the detailed description which follows, and in part will be readily apparent to those skilled in the art from that description or recognized by practicing the same as described herein, including the detailed description that follows, the claims, as well as the appended drawings.

It is to be understood that both the foregoing general description and the following detailed description present embodiments that are intended to provide an overview or framework for understanding the nature and character of the claims. The accompanying drawings are included to provide a further understanding of the disclosure, and are incorporated into and constitute a part of this specification. The drawings illustrate various embodiments and together with the description serve to explain the principles and operation.

### BRIEF DESCRIPTION OF THE FIGURES

FIG. 1A illustrates an example optical cable with a dust cap having a wavelength conversion material according to one or more embodiments described and illustrated herein.

FIG. 1B illustrates an example dust cap having a wavelength conversion material according to one or more embodiments described and illustrated herein.

FIG. 2 illustrates an example substrate having a wavelength conversion material and a scannable code according to one or more embodiments described and illustrated herein.

FIG. 3A illustrates a mobile phone and a wavelength conversion material according to one or more embodiments described and illustrated herein.

FIG. 3B illustrates a side view of a light shield according to one or more embodiments described and illustrated herein.

FIG. 3C illustrates a light shield coupled to an optical connector according to one or more embodiments described and illustrated herein.

FIG. 3D illustrates a light shield and optical cable assembly positioned on a camera of a mobile phone according to one or more embodiments described and illustrated herein.

FIGS. 4A and 4B illustrate a graphical user interface for performing a network diagnostic test according to one or more embodiments described and illustrated herein.

FIG. 5A illustrates a wall plate in a closed position according to one or more embodiments described and illustrated herein.

FIG. 5B illustrates a wall plate in an opened position according to one or more embodiments described and illustrated herein.

FIG. 5C illustrates a wall plate with a front plate removed and an adapter positioned on a connector, wherein a wavelength conversion material positioned on a front face of the adapter is not glowing according to one or more embodiments described and illustrated herein.

FIG. 5D illustrates a wall plate with a front plate removed and an adapter positioned on a connector, wherein a wavelength conversion material positioned on a front face of the adapter is glowing according to one or more embodiments described and illustrated herein.

FIG. 6A illustrates an adapter coupled to an optical connector, and an insert having a wavelength conversion material inserted into the adapter, wherein the wavelength conversion material is not glowing according to one or more embodiments described and illustrated herein.

FIG. 6B illustrates an adapter coupled to an optical connector, and an insert having a wavelength conversion material inserted into the adapter, wherein the wavelength conversion material is glowing according to one or more embodiments described and illustrated herein.

### DETAILED DESCRIPTION

Reference will now be made in detail to the embodiments of the disclosure, examples of which are illustrated in the accompanying drawings. Whenever possible, like reference numbers will be used to refer to like components or parts.

Although typically very reliable, optical communications networks have failures from time to time. For example, an optical link provided by one or more optical fibers may fail to emit an optical signal at a subscriber location for any number of reasons. Further, equipment at the subscriber location after the optical fiber at the subscriber location may be faulty or presenting a problem. It may be difficult for a user, such as a subscriber or a technician, to know whether or not the problem is upstream from the end of the optical fiber at the subscriber location (e.g., at a distribution hub, at the central office of the service provider, or some other location), or downstream from the end of the optical fiber at the subscriber location (e.g., a modem, router or other equipment at the subscriber location).

The ability to quickly isolate where the problem is occurring can save significant troubleshooting time. Embodiments of the present disclosure allow this troubleshooting function by providing optical systems that incorporate a wavelength conversion material to detect the presence or lack of presence of an optical signal when performing a network diagnostic test. As described in more detail below, the wavelength conversion material converts a communications wavelength, which is not visible to the human eyes, of the optical signal to a detection wavelength that is visible to the human eyes and/or a detection device, such as a smart device. When there is an optical signal present, the wavelength conversion material glows. Thus, the wavelength conversion material allows users, such as homeowners, renters, and business owners, to perform diagnostic tests on their own without the need for technicians. Embodiments may utilize an electronic device, such as a mobile phone, to perform optical signal verification and reporting to the service provider.

Various embodiments of optical systems for providing a network diagnostic test using a wavelength conversion material will now be described.

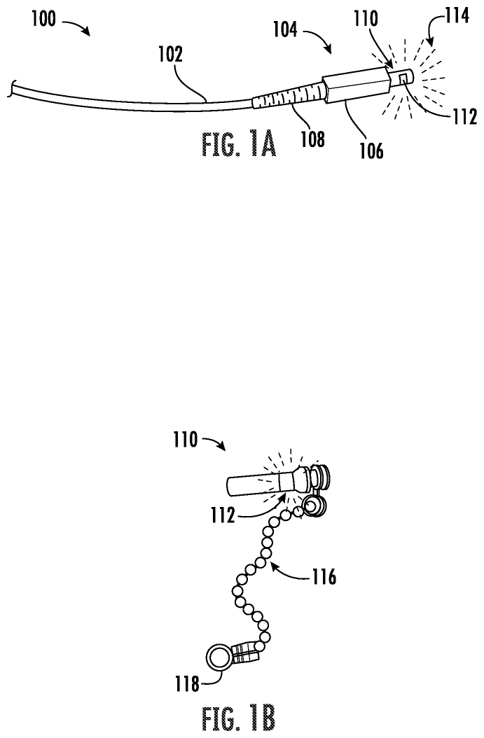

FIG. 1A illustrates an example optical system comprising an optical cable assembly 100 and a dust cap 110 incorporating a wavelength conversion material 112. The optical cable assembly 100 comprises an optical cable 102 having at least one optical fiber therein (not shown) that is terminated with in an optical connector 104. The optical connector 104 may be any style of connector, such as, without limitation, LC, SC, ST, and MPO connectors. The optical connector 104 includes a connector body 106 and a boot 108 coupled to the connector body 106 and the optical cable 102 to provide strain relieve for the optical cable 102. FIG. 1B illustrates an example dust cap 110 coupled to a tether 116 having a ring 118 or other device that may be secured to the connector body 106 or optical cable 102 to prevent the dust cap 110 from being lost.

The dust cap 110 has a wavelength conversion material 112 that is operable to convert a wavelength of an optical signal propagating within the optical fiber having a communication wavelength, which is typically in the infrared spectrum, into a detection wavelength that is capable of being detected by either human eyes or a detection device. The detection wavelength may be within the visible spectrum so it is detectable by human eyes, for example. As another example, the detection wavelength may be in the near-infrared spectrum for detection by a detection device.

As a non-limiting example, the wavelength conversion material 112 may be a phosphorescence material. The wavelength conversion material 112 may be molded with the material of the dust cap 110 during fabrication of the dust cap 110 in some embodiments. In other embodiments, the dust cap 110 is transparent to the communication wavelength of the optical signal, and the wavelength conversion material 112 is configured as a coating that is applied to an exterior and/or interior surface of the dust cap 110.

By positioning the wavelength conversion material 112 within and/or on the dust cap 110, the wavelength conversion material 112 is within an optical path of the optical signal emitted by an end of the optical fiber. The wavelength conversion material 112 converts the communication wavelength of the optical signal to a detection wavelength which is emitted through the dust cap as shown by lines 114. A technician or other user (e.g., a property owner) may view the dust cap 110 to determine if it is glowing or not. If the dust cap 110 is glowing, it is indicative of the optical link provided by the optical cable assembly 100 being operational and successful. If the dust cap 110 is not glowing, and there is an optical signal emitted at an opposite end of the optical cable assembly 100, it is indicative of the optical link provided by the optical cable assembly 100 as being non-operational and unsuccessful. Such information may be useful in troubleshooting optical communication issues.

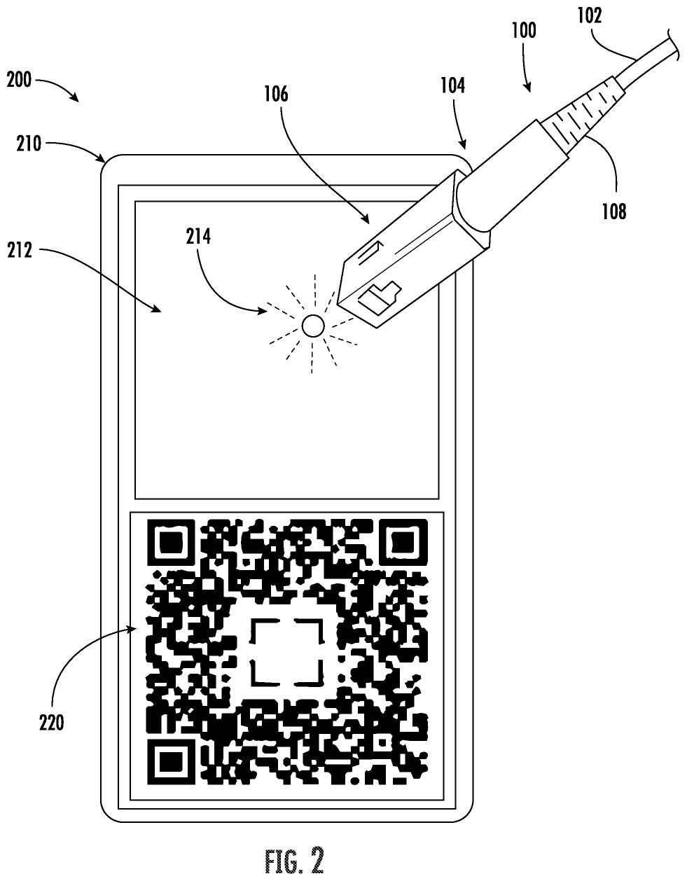

FIG. 2 illustrates another non-limiting example of an optical system 200 for detecting the operational status of an optical communications link provided by an optical cable assembly 100. In this example, the wavelength conversion material 212 is provided on a substrate 210 rather than a dust cap. The substrate 210 may be any material, such as plastic. The substrate 210 may be shaped as a rectangular card, for example, although other shapes may be utilized. The wavelength conversion material 212 is integrated in, and/or coated on, the substrate 210. The technician or other user places wavelength conversion material 212 of the substrate 210 in the optical path of the optical signal emitted by the optical fiber within the optical cable 102. If an optical signal is emitted by the optical cable assembly 100 at the communication wavelength, the wavelength conversion material will convert the communication wavelength into the detection wavelength and scatter light, as illustrated by lines 214. These lines may be visible to human eyes and/or a detection device. Light at the detection wavelength is indicative of an operational and successful optical communications link. If the wavelength conversion material 212 is not glowing, and there is an optical signal emitted at an opposite end of the optical cable assembly 100, it is indicative of the optical link provided by the optical cable assembly 100 as being non-operational and unsuccessful.

As a non-limiting example, the detection device may be a mobile phone or other smart device having a sensor capable of detecting light in the visible and/or near-infrared spectrum. The technician or other user may scan the wavelength conversion material 212 with the mobile phone or other smart device to detect light at the detection wavelength.

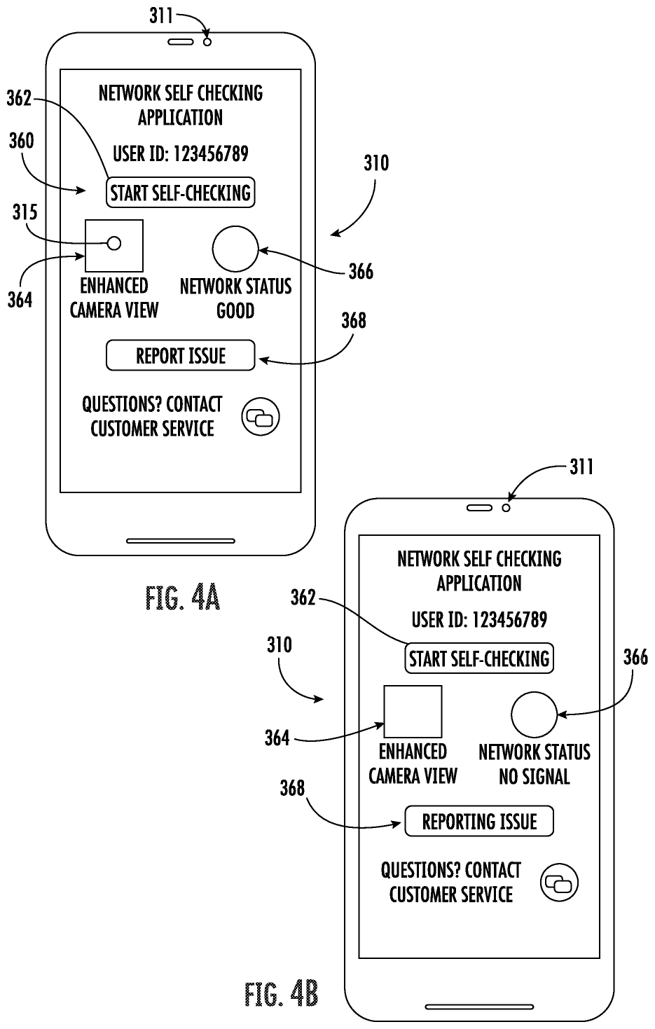

In some embodiments, an optional scannable code 220 is provided on the substrate 210. The scannable code 220 may be a QR code, a bar code, or any other type of code that may be scammed by a sensor, such as a camera sensor of a mobile phone or smart device. The scannable code 220 can be linked to an identification number corresponding to a particular subscriber and relevant subscriber information. The user may scan the scannable code 220 to log the results of a diagnostic test, for example (i.e., whether or not light is detected at the detection wavelength). In some embodiments, scanning the scannable code 220 causes a website or mobile application to launch, which instructs the user how to test the optical cable for network failure. FIGS. 4A and 4B, which are described in more detail below, illustrate an example website or mobile application.

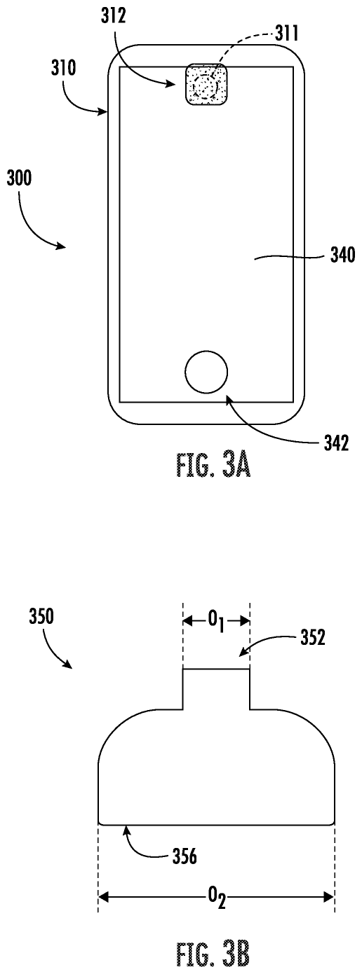

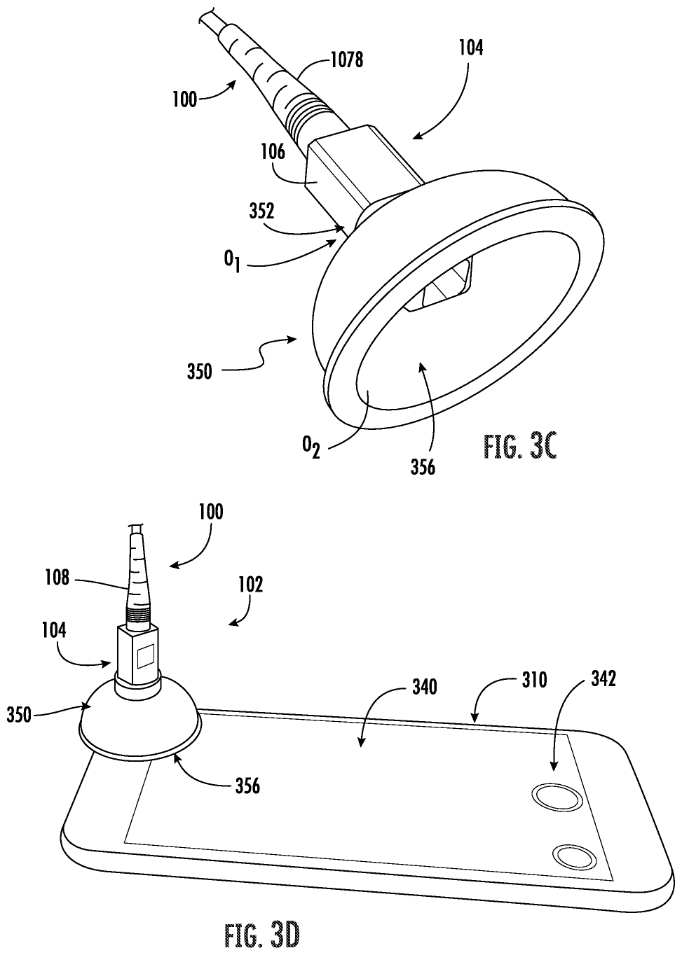

FIG. 3A illustrates another non-limiting example of an optical system 300 for optical communication network diagnostics. The optical system includes a mobile phone 310 or other smart device having a camera sensor 311. The optical system 300 further includes a wavelength conversion material 312 that is removably disposed on the camera sensor 311. The wavelength conversion material 312 may be provided on a substrate with an adhesive material, such as a sticker that can be applied to the screen of the mobile phone 310. In another embodiment, the wavelength conversion material 312 is provided in a gel that can be applied to the screen of the mobile phone.

A technician or other user may then illuminate the wavelength conversion material 312 with the communication wavelength of the optical signal emitted by the optical cable assembly 100. If the optical signal is present, then the wavelength conversion material 312 will glow. The glow of the wavelength conversion material 312 is detected by the camera sensor 311 and processed by a software application that may provide a pass/fail indication.

Referring now to FIGS. 3B and 3C, in some embodiments the optical system 300 of FIG. 3A further includes a light shield 350 operable to isolate the optical signal, the wavelength conversion material 312 and the camera sensor 311 from ambient light to better detect the glow of the wavelength conversion material 312 by the camera sensor 311.

The light shield 350 may be made of a rigid plastic or a pliable material, for example. The light shield 350 has a first opening 352 with a diameter O₁ and a second opening 356 with a diameter O₂ where O₁ is less than O₂. The first opening 352 is sized and shaped to fit over the connector body 106 as shown in FIG. 3C. The technician or other user places the larger second opening 356 over the camera sensor 311 of the mobile phone or other smart device, as shown by FIG. 3D. The light shield 350 darkens the area around the camera sensor 311. An optical signal having a communication wavelength emitted by the optical cable assembly 100 illuminates the wavelength conversion material 312, which radiates light at the detection wavelength. The technician or other user may record an image of the wavelength conversion material 312 by pressing a “take photo” icon 342, as a non-limiting example. The image data recorded by the camera sensor 311 may then be processed by the mobile phone or a remote computing device to make a determination as to whether or not light at the detection wavelength is present. Any known or yet-to-be-developed image processing algorithm may be used to detect pixels corresponding to light at the detection wavelength.

In some embodiments, the wavelength conversion material 312 may be pre-charged by illuminating it with a light source, such as a flashlight of a mobile phone or other smart device.

FIGS. 4A and 4B illustrate a non-limiting example graphical user interface 360 of a website or a mobile software application for running a network diagnostic test according to the embodiments illustrated by FIGS. 3A-3D. The example graphical user interface 360 includes a start self-checking button 362 that initiates the network diagnostic test. The user may place the light shield 350 (or only the optical connector in cases where no light shield is used) over the camera sensor 311 as described above. Upon selection of the start self-checking button 362 (or other icon to start the test), the network diagnostic test begins. In the illustrated embodiment, the graphical user interface 360 includes an enhanced camera view region 364 that shows a live view of the image data from the camera sensor 311. In the example of FIG. 4A, a illumination region 315 having the detection wavelength is present within the enhanced camera view region 364, which shows that the optical cable assembly 100 under evaluation is producing an optical signal. It should be understood that in other embodiments no enhanced camera view region 364 is provided.

It is noted that the image data shown in the enhanced camera view region 364 may be live image data when the light shield 350 and optical connector 104 are placed over the camera sensor 311 contemporaneously with running the network diagnostic test, or it may be a digital image data from a previously taken digital photo.

In some embodiments, an image processing algorithm is used to detect whether or not an illumination region 315 is present within the image data. As a non-limiting example, an edge-detection algorithm may be used to locate a shape corresponding to an illumination region of a successful test.

In the example of FIG. 4A, a test results region 366 is a status indicator that shows that an illumination region 315 was detected and the network status is good. In the example of FIG. 4B, the optical cable assembly 100 does not emit an optical signal, and therefore no illumination region is present in the enhanced camera view region 364. Further, the image processing algorithm does not detect an illumination region, and therefore the test results region 366 indicates that that no signal is present.

The graphical user interface 360 may further include a reporting issue button where the user can report a failed network diagnostic test to the service provider, which can then take further action. In some embodiments, the website or the software application automatically transmits a success indication or a failure indication depending on the results of the network diagnostic test.

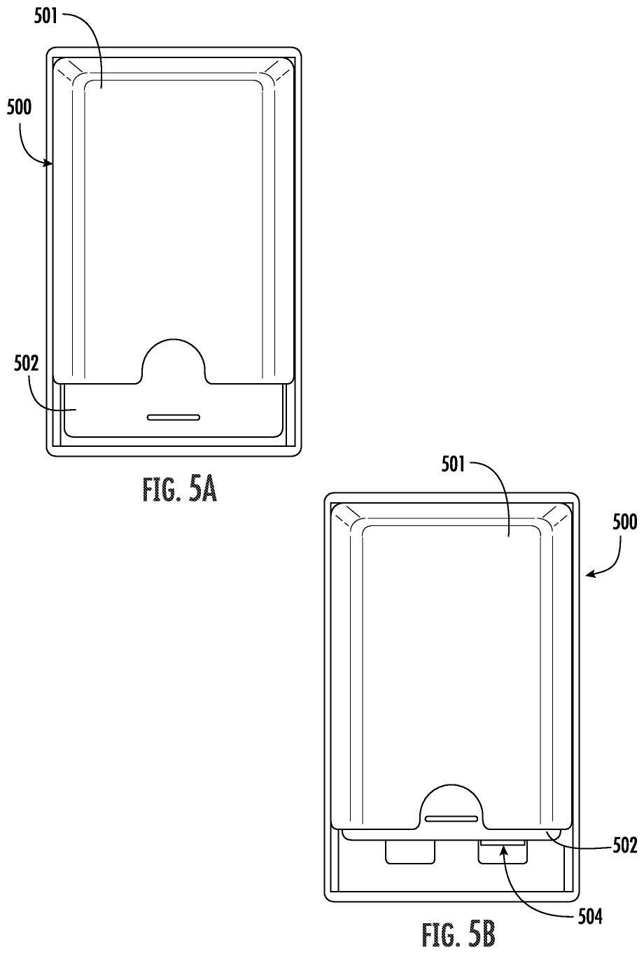

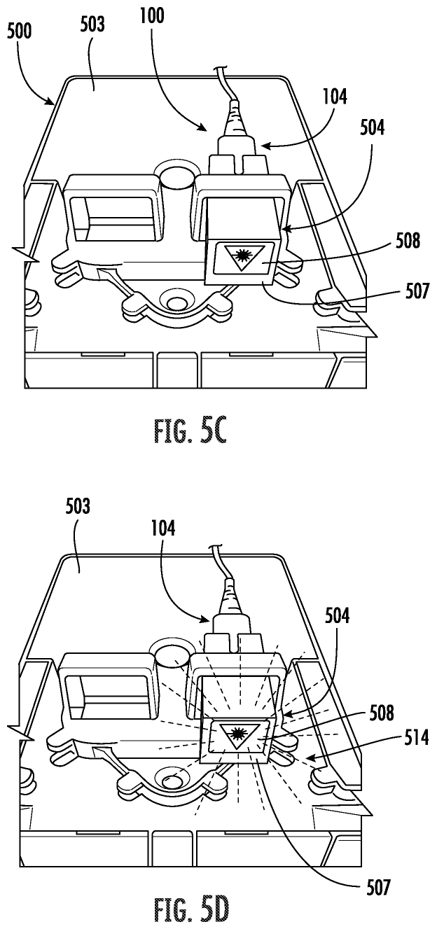

The wavelength conversion material may be provided in other ways. In some applications, the optical connector 104 is maintained within a wall plate installed on a wall of a building. FIG. 5A illustrates a wall plate 500 having a front plate 501 and a door 502 that is operable to be lowered to conceal an optical connector 104. The door 502 is further operable to be raised to expose an adapter 504 positioned on connector body 106 as shown in FIG. 5B. The adapter 504 allows for another optical component to be mated to the optical connector 104, such as another optical connector.

FIGS. 5C and 5D illustrates the wall plate 500 with the front plate 501 removed, which exposes a base plate 503 that maintains the optical connector 104 and the adapter 504. The adapter 504 shown in FIGS. 5C and 5D include a shutter 507 that blocks transmission of an optical signal from the optical connector 104 when the optical connector 104 is into in use.

In some embodiments, the wavelength conversion material may be provided in the molding of the shutter 507 or in a warning label 508 placed on the shutter 507. When no optical signal is present, as shown in FIG. 5C, the shutter 507 and/or the warning label 508 does not glow at the detection wavelength. However, when the optical signal is present, the wavelength conversion material converts the wavelength of the optical signal into the detection wavelength, which emits light 514 as shown in FIG. 5D. In this way, a user can see if an optical signal is present or not, either by the naked eye or by use of an electronic device.

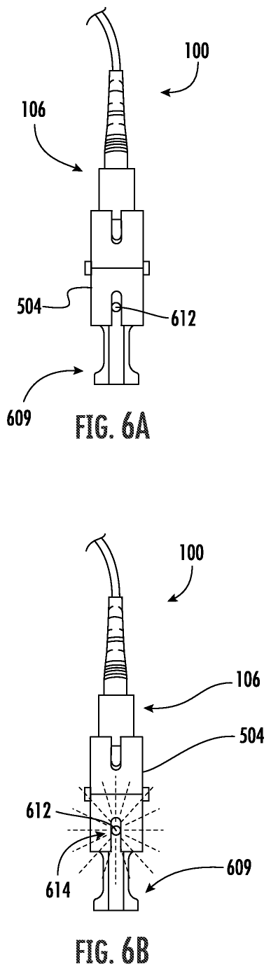

FIGS. 6A and 6B illustrate another embodiment where an insert 609 operable to be inserted into an adapter 504 to act as a shutter is illustrated. The insert 609 incorporates a wavelength conversion material 612 that converts a communication wavelength to a detection wavelength, as described above. When there is no optical signal produced by the optical cable assembly 100, the wavelength conversion material 612 of the insert 609 does not glow, as shown in FIG. 6A. However, when there is an optical signal present, the wavelength conversion material 612 emits light 614 at the detection wavelength, as shown in FIG. 6B.

It should now be understood that embodiments of the present disclosure include optical systems that incorporate a wavelength conversion material to detect the presence or lack of presence of an optical signal when performing a network diagnostic test. The wavelength conversion material allows users, such as homeowners, renters, and business owners, to perform diagnostic tests on their own without the need for technicians. Embodiments may utilize a smart device, such as a mobile phone, to perform optical signal verification and reporting to the service provider.

Although the disclosure has been illustrated and described herein with reference to explanatory embodiments and specific examples thereof, it will be readily apparent to those of ordinary skill in the art that other embodiments and examples can perform similar functions and/or achieve like results. All such equivalent embodiments and examples are within the spirit and scope of the disclosure and are intended to be covered by the appended claims. It will also be apparent to those skilled in the art that various modifications and variations can be made to the concepts disclosed without departing from the spirit and scope of the same. Thus, it is intended that the present application covers the modifications and variations provided they come within the scope of the appended claims and their equivalents.

1. An optical system comprising:
an optical cable assembly comprising an optical cable comprising at least one optical fiber and an optical connector positioned on an end of the optical cable, wherein the at least one optical fiber is operable to propagate an optical signal having a communication wavelength; and
a wavelength conversion material positioned within an optical path of the optical signal emitted by an end of the at least one optical fiber, wherein the wavelength conversion material converts the communication wavelength of the optical signal to a detection wavelength.

2. The optical system of claim 1, wherein the detection wavelength is within a visible spectrum or a near-infrared spectrum.

3. The optical system of claim 1, wherein the wavelength conversion material is a phosphorescence material.

4. The optical system of claim 1, further comprising a dust cap positioned on an end of the optical connector, wherein the wavelength conversion material is incorporated into the dust cap.

5. The optical system of claim 1, further comprising a substrate, wherein the wavelength conversion material is disposed on the substrate and operable to receive the optical signal from the at least one optical fiber propagating in free space.

6. The optical system of claim 1, further comprising a scannable code disposed on the substrate.

7. The optical system of claim 1, further comprising a substrate, wherein:
the wavelength conversion material is disposed on a first surface of the substrate and an adhesive material is disposed on a second surface of the substrate,
the substrate is operable to be attached to a camera by way of the adhesive material at the second surface, and
the wavelength conversion material is operable to receive the optical signal propagating in free space from the at least one optical fiber.

8. The optical system of claim 1, further comprising a light shield comprising a first opening, second opening, and a passage between the first opening and the second opening, wherein the optical connector is disposed within the first opening.

9. The optical system of claim 1, wherein the second opening is operable to be positioned around a camera.

10. The optical system of claim 1, further comprising an adapter, wherein the optical connector is disposed within the adapter, and the wavelength conversion material is provided on an end of the adapter.

11. The optical system of claim 10, wherein the adapter comprises a shutter, and the wavelength conversion material is provided on or within the shutter.

12. The optical system of claim 10, further comprising a substrate, wherein:
the wavelength conversion material is disposed on a first surface of the substrate and an adhesive material is disposed on a second surface of the substrate,
the substrate is operable to be attached to an end of the adapter by way of the adhesive material, and
the wavelength conversion material is operable to receive the optical signal from the at least one optical fiber.

13. The optical system of claim 10, further comprising an insert operable to be positioned within the adapter, wherein the wavelength conversion material is disposed on or within the insert.

14. A method of determining a status of an optical communication link, the method comprising:
receiving image data of a wavelength conversion material positioned to receive an optical signal having a communication wavelength, wherein the wavelength conversion material is operable to convert the communication wavelength of the optical signal to a detection wavelength; and
processing the image data to determine a presence or lack of presence of an illumination region that is illuminated by the optical signal; and
providing a success indication when the processing of the image data is indicative of a presence of an illumination region.

15. The method of claim 14, further comprising receiving image data of a code associated with an identification number, and linking the image data to the identification number.

16. The optical system of claim 14, wherein the detection wavelength is within a visible spectrum or a near-infrared spectrum.

17. The optical system of claim 14, wherein the wavelength conversion material is a phosphorescence material.

18. The optical system of claim 14, further comprising:
transmitting the success indication when the processing of the image data is indicative of the presence of the illumination region; and
transmitting a failure indication when the processing of the image data is not indicative of an illumination region.

19. A method of determining a status of an optical communication link, the method comprising:
placing a substrate comprising a wavelength conversion material over a camera of an electronic device;
positioning a light shield over an optical connector of an optical cable assembly, wherein the light shield comprises a first opening, second opening, and a passage between the first opening and the second opening; and
placing the second opening of the light shield over the wavelength conversion material and the camera of the electronic device.

20. The method of claim 19, wherein the wavelength conversion material is a phosphorescence material.

21. The method of claim 19, wherein the substrate comprises a gel.

22. The method of claim 19, wherein the substrate comprises an adhesive material on one side.

23. The method of claim 19, wherein the electronic device is a mobile phone.

24. The method of claim 19, further comprising receiving a status indicator from the electronic device.

25. The method of claim 19, further comprising illuminating the substrate with a light source prior to placing the substrate over the camera of the electronic device.

26. The method of claim 19, wherein the light source is a flashlight of the electronic device.
